(19) United States
(12) Patent Application Publication
(10) Pub. No.: US 2013/0321943 A1
(43) Pub. Date: Dec. 5, 2013

(54) OPTICAL PANEL AND PROCESSING METHOD THEREOF

(71) Applicant: ASUSTeK COMPUTER INC., Taipei (TW)

(72) Inventors: Yen-Hsun CHEN, Taipei (TW); Yu-Wei LO, Taipei (TW); Shiao-Pei HUANG, Taipei (TW); Tsung-Ming HUNG, Taipei (TW)

(73) Assignee: ASUSTeK COMPUTER INC., Taipei (TW)

(21) Appl. No.: 13/902,103

(22) Filed: May 24, 2013

Related U.S. Application Data
(60) Provisional application No. 61/652,995, filed on May 30, 2012.

(30) Foreign Application Priority Data
Apr. 8, 2013 (TW) 102112340

(51) Int. Cl. F21V 11/14

(52) U.S. Cl. CPC F21V 11/14
USPC 359/893; 430/321

(57) ABSTRACT

A processing method of an optical panel used in an electronic device is disclosed. The processing method includes: selecting a light transparent panel and coating a photoresist on one surface of the light transparent panel; forming a plurality of light transmission hole patterns on a photomask; and forming a light shielding layer after the photoresist is exposed via the photomask and developing; and the light transmission hole patterns are transferred to the light shielding layer and a plurality of light transmission holes are formed on the light shielding layer.

### CROSS-REFERENCE TO RELATED APPLICATION

This application claims the priority benefit of U.S. provisional application Ser. No. 61/652, 995, filed on May 30, 2012, and Taiwan application serial no. 102112340, filed on Apr. 8, 2013. The entirety of the above-mentioned patent applications are hereby incorporated by reference herein and made a part of specification.

### BACKGROUND OF THE INVENTION

1. Field of the Invention

The invention relates to an optical panel and, more particularly, to an optical panel applied to an electronic device.

2. Description of the Related Art

It tends to further pursuit the overall design and aesthetic development of electronic device, especially portable electronic devices, except for the pursuit on the performance improvement and being thinner and lighter. Taking a panel of a notebook, a tablet PC or a smartphone as an example, in order to meet the requirements of aesthetic, the frame and the panel are integrated without gaps, and it is commonly called as the panel. The original position of the frame, at the back of the panel, that is the interior of the electronic device is coated with a layer of ink to shield the internal structure.

The light sensors, a LED (Light Emitting Diode) or other light sources are installed in the panel of the notebook computer or a Tablet computer. The light sensors are used to sense the light of the external environment and the LED or the other light sources are provided as the flash light element or an indicator light element of a camera module. If the aforementioned optical elements are placed behind the panel, it needs to punch translucent holes on the panel to allow the light to pass through; otherwise it is impossible to achieve its function. However, users can see the sensors or LED lights inside the body directly from the light transmission holes, thereby affecting the overall appearance of the computer or Tablet PC.

### BRIEF SUMMARY OF THE INVENTION

The invention discloses a processing method of an optical panel applied to an electronic device, the processing method comprises: selecting a light transparent panel and coating a photoresist on one surface of the light transparent panel; forming a plurality of light transmission hole patterns on a photomask; and forming a light shielding layer after the photoresist is exposed via the photomask and developing; and the light transmission hole patterns are transferred to the light shielding layer and a plurality of light transmission holes are formed on the light shielding layer.

The invention further discloses an optical panel applied to an electronic device, comprises a light transparent panel, a light shielding layer and an optical element. The light shielding layer is disposed on one surface of the light transparent panel and includes a plurality of light transmission holes. The optical element is disposed adjacent to the surface of the light transparent panel with the light-shielding layer and corresponding to the light transmission holes.

The optical panel applied to an electronic device and the processing method are based on lithography and replacing the extra process of coating the ink on frame part by coating the photoresist directly. A plurality of light transmission holes on the shielding layer are generated by the design of photomask, the exposure processing, and the development processing of the photoresist, and the appearance of the transparent pane is maintained.

In addition, the shielding layer comprises a black matrix layer, so that the light transparent panel is opaque, the internal components in the electronic device are shielded. It maintains the aesthetic appearance of the electronic device. Similarly, the light transmission hole pattern formed by the light transmission holes not only allows the light to pass through the light transparent panel directly, but also enables the light transmission hole pattern hidden in the optical panel to achieve aesthetic effects.

### BRIEF DESCRIPTION OF THE DRAWINGS

FIG. 1A is a schematic diagram showing an optical panel used in an electronic device in an embodiment.

FIG. 1B is a partial enlarged drawing showing the optical panel in FIG. 1A.

FIG. 2 is a schematic diagram showing of the optical panel in FIG IA viewed from the cross-section A-A.

FIG. 3A is an enlarged drawing showing the light transmission hole pattern in FIG. 1A,

FIG. 3B is an enlarged drawing showing the light transmission hole pattern in FIG. 1A in another embodiment.

FIG. 4 is a flow block diagram showing the processing method of an optical panel in an embodiment.

FIG. 5 is flow diagram showing the processing method of an optical panel shown in FIG. 4.

FIG. 6 is a schematic diagram showing the photomask pattern according to the step S20 shown in FIG. 4.

### DETAILED DESCRIPTION OF THE EMBODIMENTS

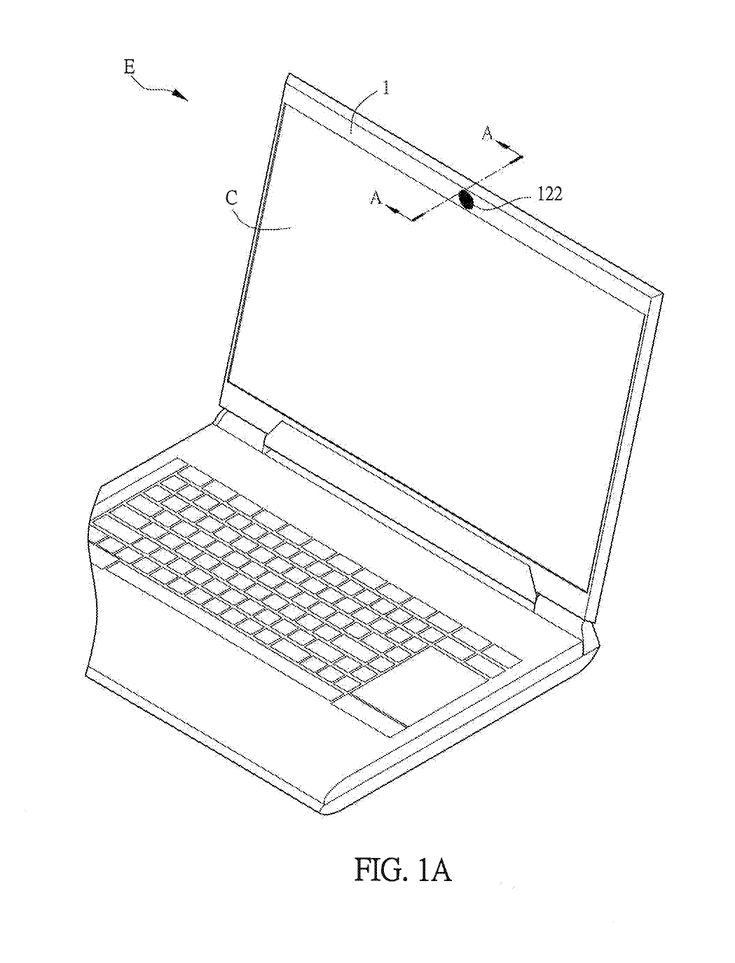

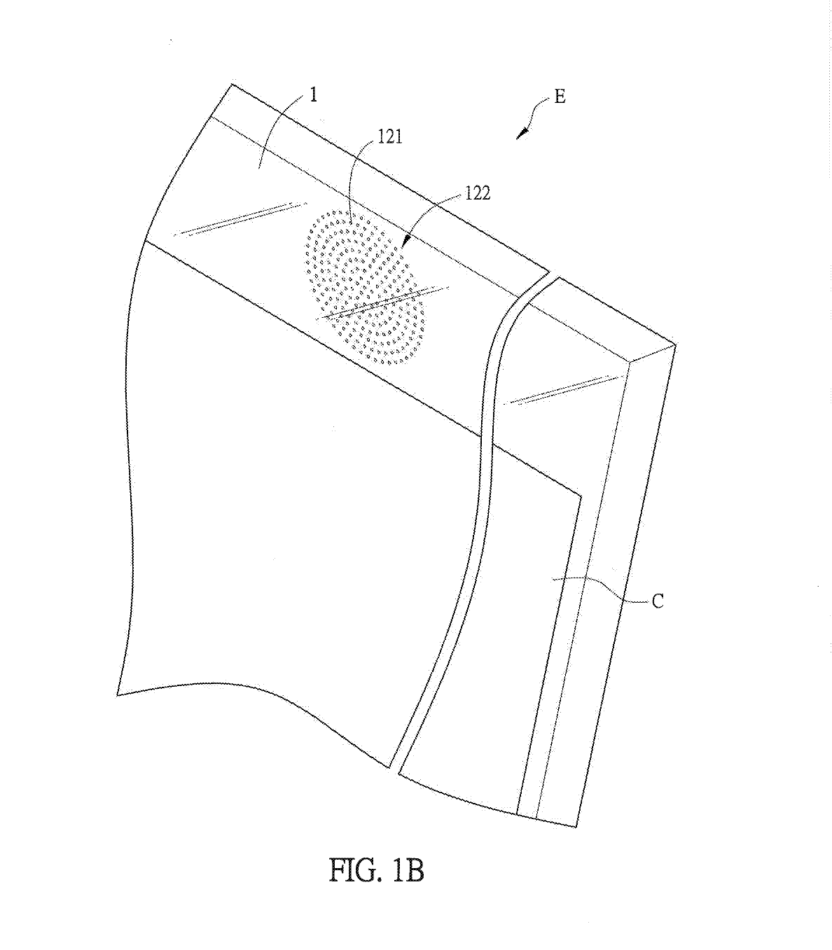

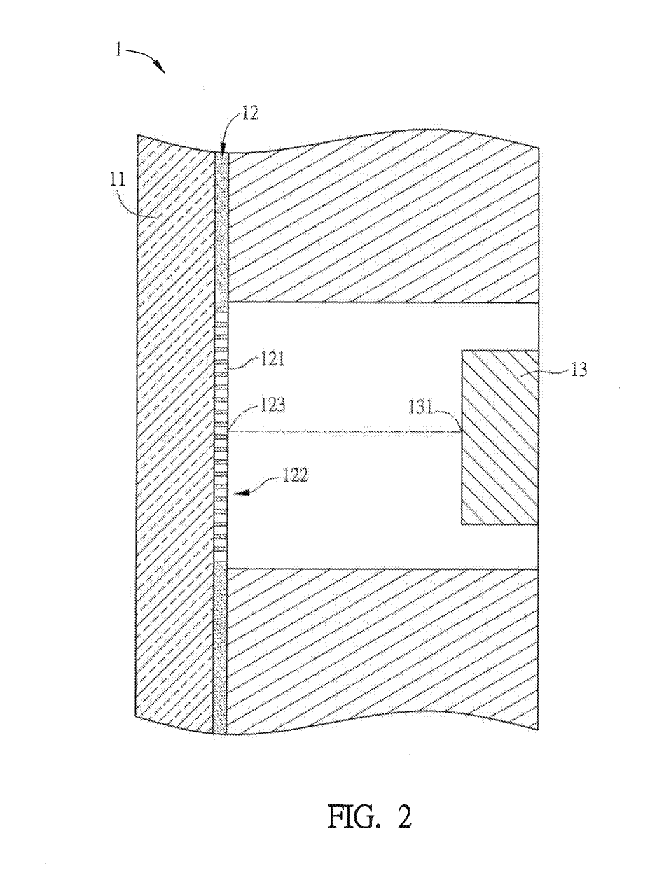

FIG. 1A is a schematic diagram showing an optical panel used in an electronic device in an embodiment. FIG. 1B is a partial enlarged drawing showing the optical panel in FIG. 1A. FIG. 2 is a schematic diagram showing the cross-section A-A of the optical panel in FIG. 1A. As shown in FIG. 1, an optical panel 1 is mainly used at an electronic device E. Please refer to the FIG. 1B and FIG. 2, the optical panel 1 includes a light transparent panel 11, a light shielding layer 12 and an optical element 13. The light transparent panel 11 may be but not limited to glass, acrylic or transparent film as long as it is a transparent material. The light shielding layer 12 is disposed on one surface of the light transparent panel 11 and includes a plurality of light transmission holes 121. The optical element 13 is disposed adjacent to the surface of the light transparent panel 11 with the light-shielding layer 12.

The light shielding layer 12 can make the light transparent panel 11 opaque to shield the internal components of the electronic device E. The light shielding layer 12 may be a black matrix layer, a metallic chromium black matrix layer, and a resin black matrix layer, a graphite black matrix layer, or a non-electrolytic plating nickel black matrix layer, which is not limited therein.

As shown in FIG. 2, the optical element 13 may be a light sensor of the camera module to sense and receive the light of the external environment, or may be a flash light element or an indicator light element of the camera module, which is not limited herein. The optical element 13 is corresponding to the light transmission holes 121 and disposed adjacent to the surface of the light transparent panel 11 having the light-shielding layer 12. The external light or the light of the optical element 13 can pass through the light transparentpanel 11 via the light transmission holes 121. The light transmission holes 121 form a light transmission hole pattern 122 (as shown in FIG. 1A and FIG. 1B). Preferably, the light transmittance of the light transmission hole pattern 122 is over 10%.

The light transmission hole 121 shown in FIG. 1A and FIG. 1B is a hollow structure disposed on the light transparent panel 11 adjacent to the internal side of the electronic device E, so the relevant figures are drawn in thin lines. However, in practical application, the light transmission hole 121 is a dense and subtle hollow structure, and it cannot be easily noticed by naked-eyes.

In actual operation, firstly, testing the photosensitive illumination of the light sensor of the camera module and the luminous illumination of the flash light element or indicator light element to determine the required light transmittance of the light transmission hole pattern 122 to allow the light sensor sense the light source or the light of the flash light element or the indicator light element to pass through. Preferably, the light transmittance over 10% is the threshold. When the required light transmittance is determined, the diameter and spacing of the light transmission hole 121, and the pattern and the size of the light transmission hole pattern 122 are further designed.

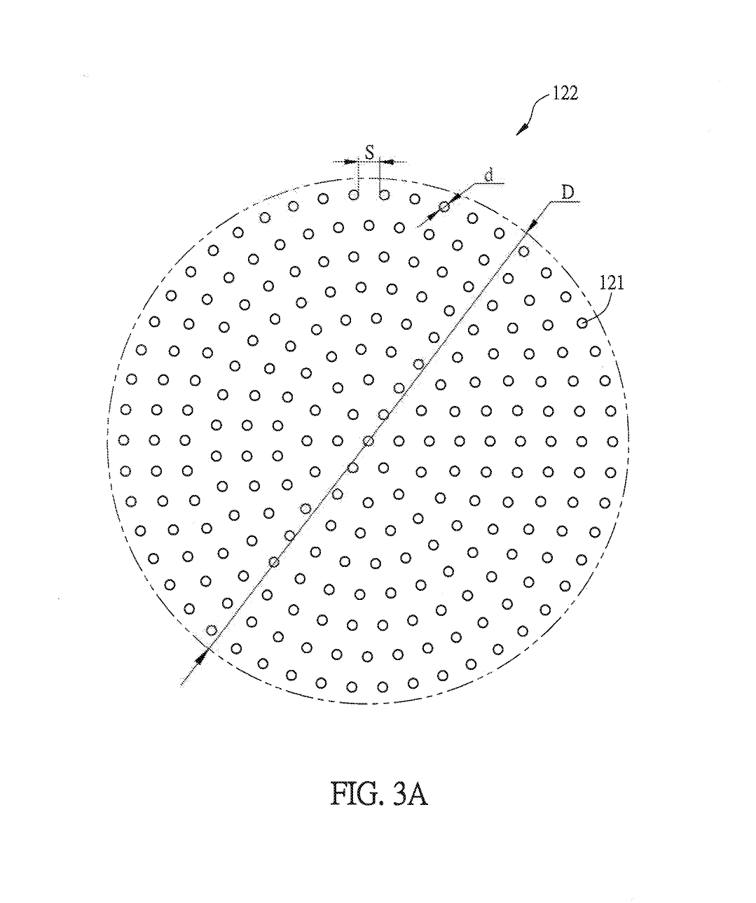

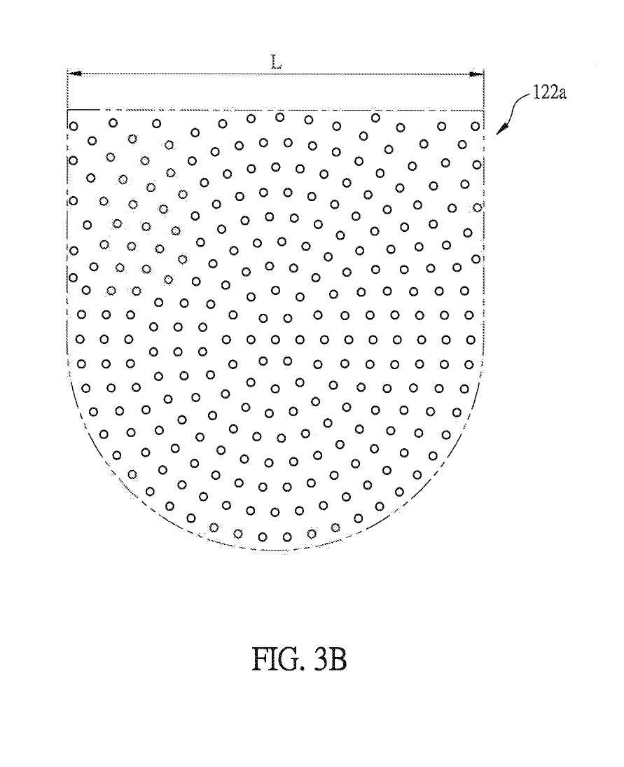

FIG. 3A is an enlarged drawing showing the light transmission hole pattern in FIG. 1A. Please refer to the FIG. 3A, light transmission hole 121 includes circular holes and diameter d of the circular holes is 40 μm to 70 μm. The spacing S between two adjacent light transmission holes is 0.1 mm to 0.3 mm. However, light transmission holes 121 may have any other shapes, and the diameter d and the spacing S may be adjusted at random as long as they match the configuration of the light transmission hole pattern 22 to achieve the desired light transmittance.

As shown in FIG. 3A, in the embodiment, the light transmission hole 121 is concentrically arranged to form the light transmission hole pattern 122, and the light transmission hole pattern 122 is a circular structure. The light transmission hole 121. also may be radially arranged, concentrically arranged, dislocation arranged, honeycomb-like arranged, hexagonal arranged, or spirally arranged to form the light transmission hole pattern 122, which is not limited herein. Please refer to FIG. 2, preferably, the center 123 of the light transmission hole pattern 122 corresponds to the center 131 of the optical element 13, and the diameter D of the light transmission hole pattern 122 may be 2 mm to 3 mm, which is not limited here, as long as the transmittance is greater than 10% or other appropriate light transmittance.

In addition, the light transmission hole pattern 122 is not limited to a circular configuration, preferably, as shown FIG. 3B, FIG. 3B is an enlarged drawing showing the light transmission hole pattern in FIG. 1A in another embodiment. The light transmission hole pattern 122 also can be a bowl-shaped structure with two parallel sides and a curved bottom, and the distance L between the parallel sides may be but not limited to 2 mm to 3 mm. The invention is not limited to the above embodiments, as long as the transmittance is appropriate to allow the sensor of the camera module to detect the light or allow the light of the flash light element, the indicator light element to pass through.

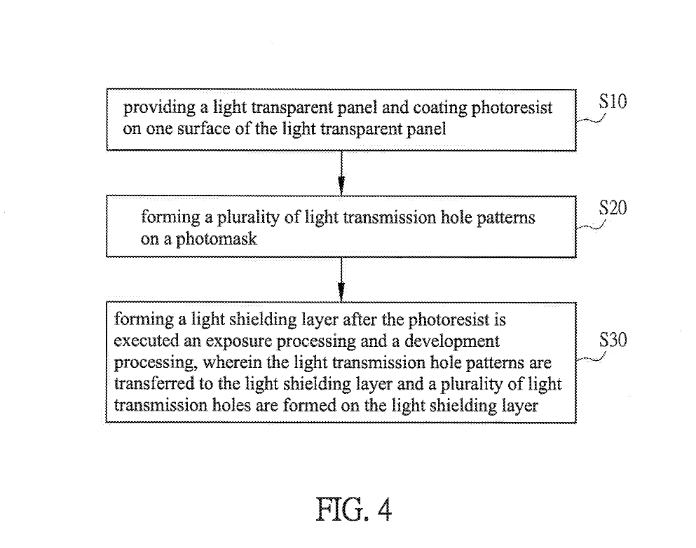

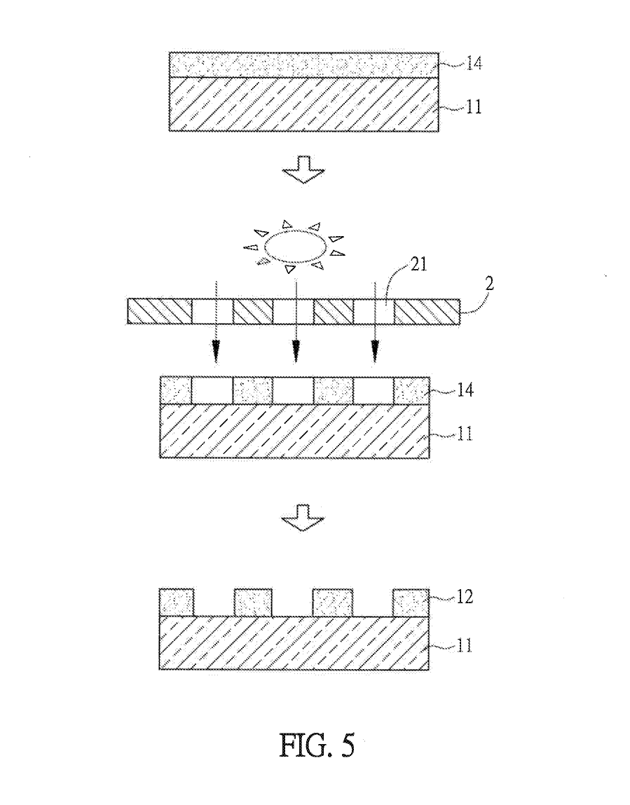

The processing method of an optical panel in an embodiment is based on the lithography process. The material or configuration of the same components has been illustrated above, which is omitted here. FIG. 4 is a flow block diagram showing the processing method of an optical panel in an embodiment, FIG. 5 is flow diagram showing the processing method of an optical panel shown in FIG. 4. Please refer to FIG. 4 and FIG. 5, the processing method of the optical panel 1 includes the following steps, selecting a light transparent panel and coating a photoresist on one surface of the light transparent panel (S10); forming a plurality of light transmission hole patterns on a photomask (S20); forming a light shielding layer after the photoresist is executed an exposure processing via the photomask and development processing, and the light transmission hole patterns are transferred to the light shielding layer and a plurality of light transmission holes are formed on the light shielding layer (S20).

In the step S10, selecting a light transparent panel 11 and coating a layer of photoresist 14 on one surface of the light transparent panel 11, wherein the photoresist 14 is a mixture of adhesives and sensitizer and includes carbon particles or other light-opaque materials. Preferably, for example, the photoresist 14 may be a black matrix photoresist mixing carbon particles with metallic chromium, resin, or electroplating nickel, which is not limited herein, and it is coated on the light transparent panel 11 to make the light transparent panel 11 opaque to shield the internal components of the electronic device E.

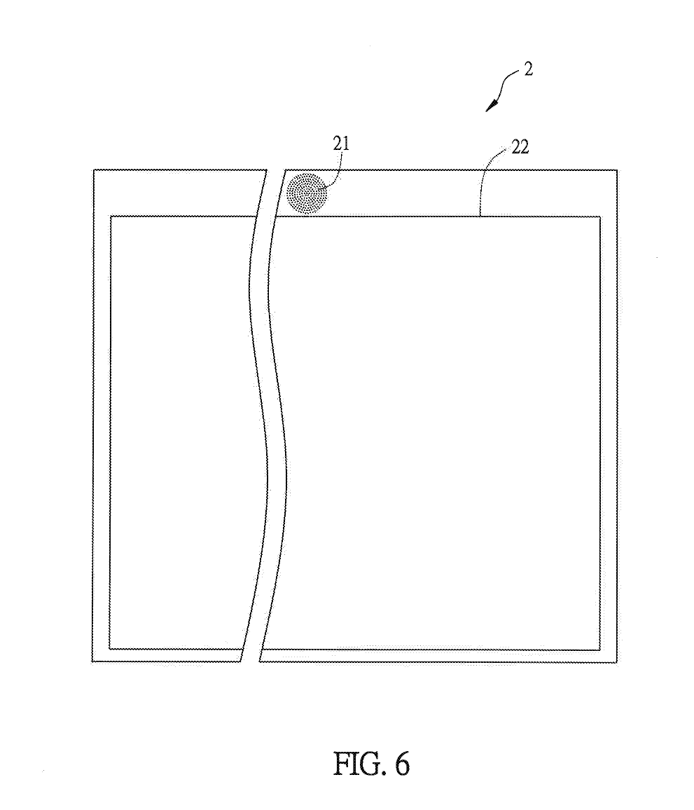

In step S20, a plurality of light transmission hole-patterns 21 are designed on the photomask as shown in FIG. 6. FIG. 6 is a schematic diagram showing the photomask pattern in the step S20 shown in FIG. 4. In addition, the photomask 2 further includes a hollow pattern 22. The light transmission hole pattern 21 is designed according to the light transmission hole 121. The configuration of the hollow pattern 22 is configured corresponding to the screen C of the electronic device E.

Please refer to FIG. 5 and FIG. 6, in step S30, the photomask is disposed corresponding to the photoresist 14, for example, ultraviolet light UV (which is not limited herein) irradiates the photomask 2, and the ultraviolet light passes through the photomask 2 to make the photoresist 14 exposed and developed, for forming a light-shielding layer 12. The light transmission hole pattern 21 and the hollow pattern 22 should be formed based on the type of sensitizer contained in the photoresist 14, that is, whether the photoresist 14 is a positive photoresist or a negative photoresist. For example, the photoresist 14 dissociates to a positive photoresist which can dissolve in a developer when the photoresist 14 is exposed in light, and thus the light transmission hole pattern 21 and hollow pattern 22 must be a hollow structure.

As shown in FIG. 5, the photoresist 14 with a sensitizer is exposed when the ultraviolet light UV irradiates the photoresist 14 via the photomask 2, and the cross-linked structure of the photoresist 14 is destroyed due to the light. During the development process, the photoresist 14 (that is the light transmission hole pattern 21 and the hollow pattern 22) is exposed in light, light transmission hole pattern eroded and dissolved in the developer. The portion not irradiated by the ultraviolet light UV forms a light-shielding layer 12, and the light transmission hole pattern 21 forms a hollow structure of the light transmission hole 121. In other words, the light transmission hole pattern 21 is transferred to the shielding layer 12 and a plurality of light transmission holes 121 are formed on the shielding layer 12. The relating configuration and characteristics of the light transmission holes 121 have been illustrated above and are omitted herein. In addition, the hollow pattern 22 also may be a hollow structure provided corresponding to the screen C.

In addition, if the photoresist 14 is a negative photoresist which can generate a link and strengthen structure when exposed in light, the light transmission hole pattern 21 and the hollow pattern 22 must be a solid structure that the photoresist 14 cannot be dissolved in the developer to form a hollow structure when the ultraviolet light UV irradiates photoresist 14.

Although the present invention has been described in considerable detail with reference to certain preferred embodiments thereof, the disclosure is not for limiting the scope. Persons having ordinary skills in the art may make various modifications and changes without departing from the scope. Therefore, the scope of the appended claims should not be limited to the description of the preferred embodiments described above.

What is claimed is:

1. A processing method of an optical panel used in an electronic device, the processing method comprising:
providing a light transparent panel and coating photoresist on one surface of the light transparent panel;
forming a plurality of light transmission hole patterns on a photomask; and
forming a light shielding layer after the photoresist is executed an exposure processing via the photomask and a development processing, wherein the light transmission hole patterns are transferred to the light shielding layer, and a plurality of light transmission holes are formed on the light shielding layer.

2. The processing method of an optical panel according to claim 1, wherein the light transmission holes form a light transmission hole pattern.

3. The processing method of an optical panel according to claim 1, wherein the diameter of the light transmission holes is 40 μm to 70 μm.

4. The processing method of an optical panel according to claim 1, wherein the spacing between two light transmission holes is 0.1 mm to 0.3 mm.

5. The processing method of an optical panel according to claim 1, wherein the light transmittance of the light transmission hole pattern is over 10%.

6. The processing method of an optical panel according to claim 1, wherein the light shielding layer includes a black matrix layer.

7. An optical panel applied to an electronic device, comprising:
a light transparent panel,
a light shielding layer, disposed on one surface of the light transparent panel and including a plurality of light transmission holes, and
an optical element, disposed adjacent to the surface of the light transparent panel with the light-shielding layer and corresponding to the light transmission holes.

8. The optical panel according to claim 7, wherein light transmission holes form a light transmission hole pattern.

9. The optical panel according to claim 7, wherein the diameter of the light transmission holes is 40 μm to 70 μm.

10. The optical panel according to claim 7, wherein the spacing between two light transmission holes is 0.1 mm to 0.3 mm.

11. The optical panel according to claim 7, wherein the light transmittance of the light transmission hole pattern is over 10%.

12. The optical panel according to claim 7, wherein the light shielding layer includes a black matrix layer.
